(19) United States
(12) Patent Application Publication
(10) Pub. No.: US 2026/0115585 A1
(43) Pub. Date: Apr. 30, 2026

(54) ROCKER DEVICE AND REMOTE CONTROL

(71) Applicant: GUANGDONG K-SILVER INDUSTRIAL CO., LTD., Shenzhen (CN)

(72) Inventors: Xiao ZENG, Shenzhen (CN); Jianbo ZHAO, Shenzhen (CN); Hui QIU, Shenzhen (CN)

(73) Assignee: GUANGDONG K-SILVER INDUSTRIAL CO., LTD., Shenzhen (CN)

(21) Appl. No.: 19/343,369

(22) Filed: Sep. 29, 2025

(30) Foreign Application Priority Data
Oct. 24, 2024 (CN) 202422583466.0

(51) Int. Cl. A63F 13/24; A63F 13/211; A63F 13/235

(52) U.S. Cl. CPC A63F 13/24; A63F 13/211; A63F 13/235

(57) ABSTRACT

A rocker device includes a rocker, a rocker arm assembly, a first circuit board, a first tunnel magneto resistance (TMR) sensing assembly, a second circuit board, and a second TMR sensing assembly. The rocker arm assembly includes an upper rocker arm and a lower rocker arm provided orthogonally to each other, and the rocker passes through the upper rocker arm and lower rocker arm. The first TMR sensing assembly includes a first TMR sensing element and a first magnet, and the first magnet is provided at the peripheral side of the upper rocker arm and integrally provided with the upper rocker arm. The second TMR sensing assembly includes a second TMR sensing element and a second magnet, and the second magnet is provided at the peripheral side of the lower rocker arm and integrally provided with the lower rocker arm.

### CROSS-REFERENCE TO RELATED APPLICATIONS

This application claims priority to Chinese Patent Application No. 202422583466.0, filed on October 24, 2024, the entire contents of which are incorporated herein by reference.

### TECHNICAL FIELD

The present application relates to the technical field of remote control, in particular to a rocker device and a remote control.

### BACKGROUND

With the development of the gaming industry, users have placed higher demands on the accuracy and response speed of game operations. Existing rocker devices often have problems with insufficient accuracy and response delay during complex operations, affecting the gaming experience.

### SUMMARY

The main purpose of the present application is to provide a rocker device and a remote control to enhance the user experience.

In order to achieve the above purpose, the rocker device provided in the present application includes: a rocker; a rocker arm assembly; a first circuit board; a first tunnel magneto resistance (TMR) sensing assembly; a second circuit board; and a second TMR sensing assembly.

In an embodiment, the rocker arm assembly includes an upper rocker arm and a lower rocker arm provided orthogonally to each other, and the rocker passes through the upper rocker arm and lower rocker arm.

In an embodiment, the first TMR sensing assembly includes a first TMR sensing element and a first magnet, the first magnet is provided at a peripheral side of the upper rocker arm and integrally provided with the upper rocker arm, and the first TMR sensing element is provided at the first circuit board at a position corresponding to the first magnet and electrically connected to the first circuit board.

In an embodiment, the second TMR sensing assembly includes a second TMR sensing element and a second magnet, the second magnet is provided at a peripheral side of the lower rocker arm and integrally provided with the lower rocker arm, and the second TMR sensing element is provided at the second circuit board at a position corresponding to the second magnet and electrically connected to the second circuit board.

In an embodiment, the first magnet and the upper rocker arm are integrally formed, and the second magnet and the lower rocker arm are integrally formed.

In an embodiment, the first magnet is of a cylindrical shape, and the second magnet is of a cylindrical shape.

In an embodiment, opposite radial sides of the first magnet and the second magnet have opposite polarities.

In an embodiment, the rocker device includes a housing, the housing includes a base and an upper housing, and the upper housing is provided at the base and enclose with the base to form a mounting space; and the rocker arm assembly is provided in the mounting space, and an end of the rocker arm passes through the upper housing.

In an embodiment, the housing includes a first cover housing and a second cover housing provided at the upper housing, and the first circuit board is provided in the first cover housing and located between the upper housing and first cover housing; and the second circuit board is provided in the second cover housing and located between the upper and second cover housings.

In an embodiment, the first cover housing is provided with a first buckle, and the upper housing is provided with a first clamping groove for the first buckle to snap; and the second cover housing is provided with a second buckle, and the upper housing is provided with a second clamping groove for the second buckle to snap.

In an embodiment, the upper rocker arm includes an upper rocker arm body, a first clamping portion, a second clamping portion, and a first mounting portion; the first clamping portion and the second clamping portion are provided at opposite sides of the upper rocker arm body, the upper rocker arm body is provided in the mounting space, and a clamping groove for mounting the first clamping portion and second clamping portion is formed between the base and the upper housing; and the first mounting portion is provided at a side of the first clamping portion away from the upper rocker arm body and is located between the upper housing and the first cover housing, and the first magnet and the first mounting portion are integrally formed.

In an embodiment, the lower rocker arm includes a lower rocker arm body, a third clamping portion, a fourth clamping portion, and a second mounting portion; the third clamping portion and the fourth clamping portion are provided at opposite sides of the lower rocker arm body, the lower rocker arm body is provided in the mounting space, and a clamping groove for mounting the third clamping portion and the fourth clamping portion is formed between the base and the upper housing; and the second mounting portion is provided at a side of the fourth clamping portion away from the lower rocker arm body and is located between the upper housing and the second cover housing, and the second magnet and the second mounting portion are integrally formed.

The present application provides a remote control, the remote control includes the rocker device described above.

In the technical solution of the present application, the first tunnel magneto resistance (TMR) sensing element and the second TMR sensing element are directly integrated on the circuit board, and correspond to the magnets of the upper rocker arm and the lower rocker arm. The first TMR sensing element corresponding to the first magnet is integrally provided with the upper rocker arm, and the second TMR sensing element corresponding to the second magnet is integrally provided with the lower rocker arm. The integrated arrangement of the magnet and the rocker arm prevents the magnet from changing due to loosening or displacement during installation or use, which enables the TMR sensing element to better sense the position change of the magnet, improves the detection accuracy, simplifies the assembly process, and reduces the accuracy problem caused by assembly errors. In addition, the integrated design of the magnet and the rocker arm enables the movement of the rocker arm to be better reflected on the magnet, reduces the lag in the signal transmission path, and improves the response speed of the system. In addition, due to the characteristics of the output signal of the TMR sensing element, the signal processing system on the circuit board can process these signals more efficiently, thereby further reducing the response delay of the overall system and providing a better user experience.

### BRIEF DESCRIPTION OF THE DRAWINGS

In order to more clearly illustrate the embodiments of the present application or the technical solutions in the prior art, the following briefly describes the drawings required for use in the embodiments or prior art descriptions. Obviously, the drawings described below represent only some embodiments of the present application. Person skilled in the art can, without inventive effort, derive other drawings based on the structures shown in these drawings.

FIG. 1 is a schematic structural view of a rocker device according to an embodiment of the present application.

FIG. 2 is a partial exploded view of FIG. 1.

FIG. 3 is a further exploded view of FIG. 1.

FIG. 4 is a cross-sectional view from one perspective of FIG. 1.

FIG. 5 is a cross-sectional view from another perspective of FIG. 1.

FIG. 6 is a schematic structural view of a polarity distribution of a first magnet or a second magnet according to an embodiment of the present application.

FIG. 7 is a graph showing a relationship between a rotation angle of an upper rocker arm or a lower rocker arm and an output voltage of the present application.

The purpose, features, and advantages of the present application will be further explained with reference to the accompanying drawings and embodiments.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicating the number of technical features indicated. Thus, a feature delimited with “first”, “second” may expressly or implicitly include at least one of these features. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of the present application.

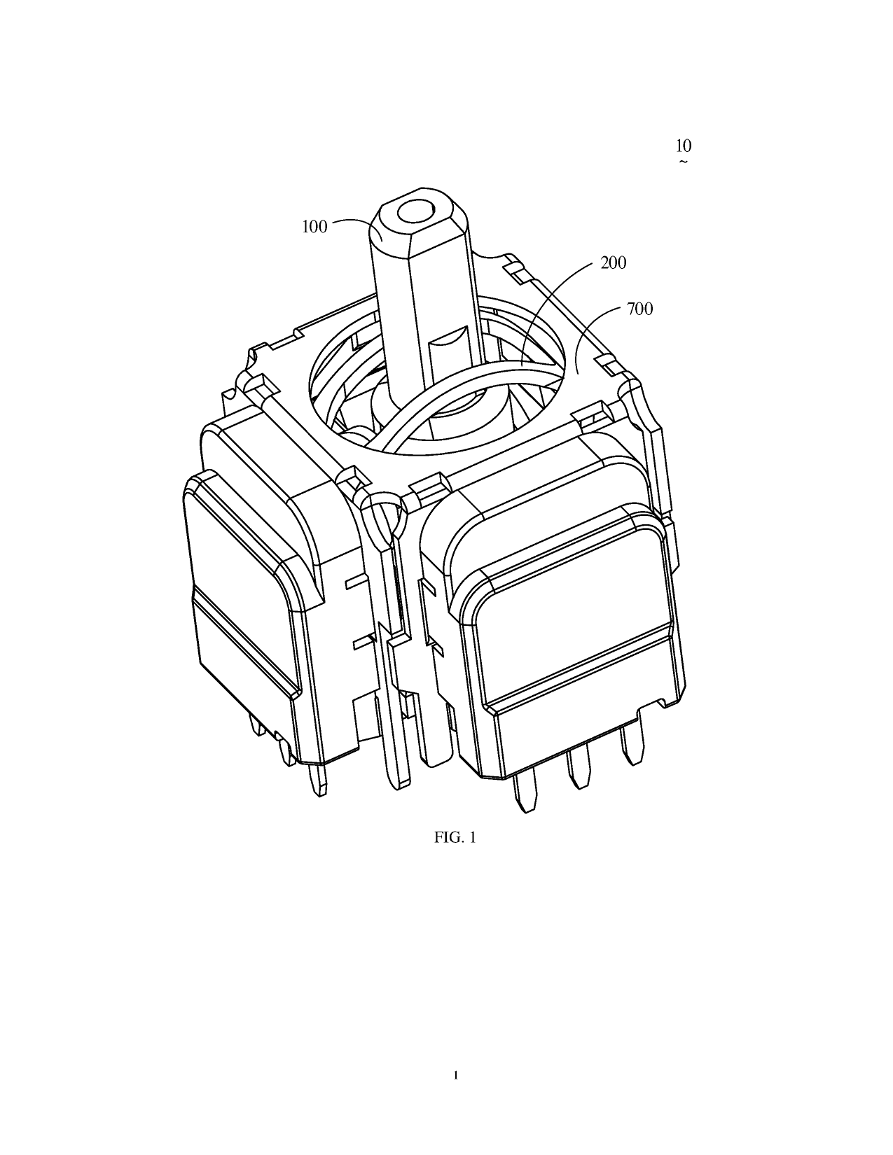

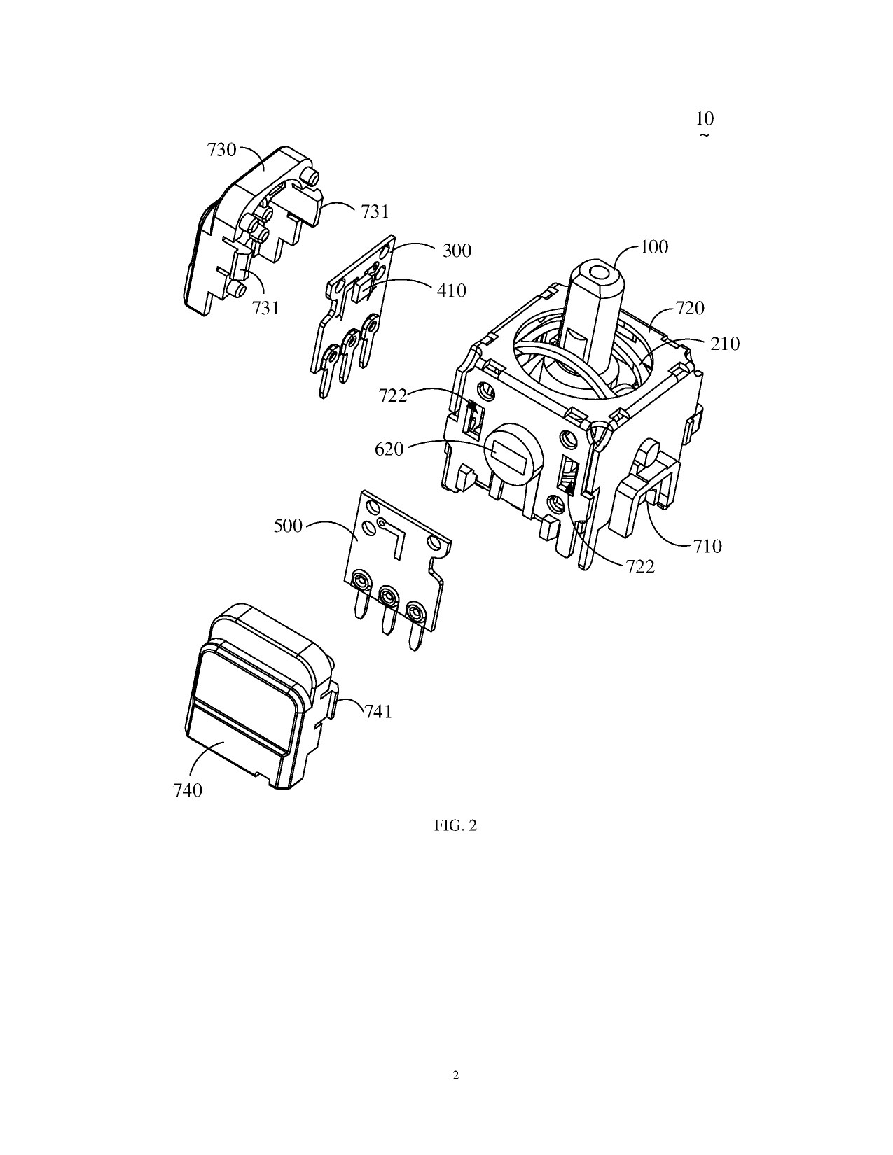

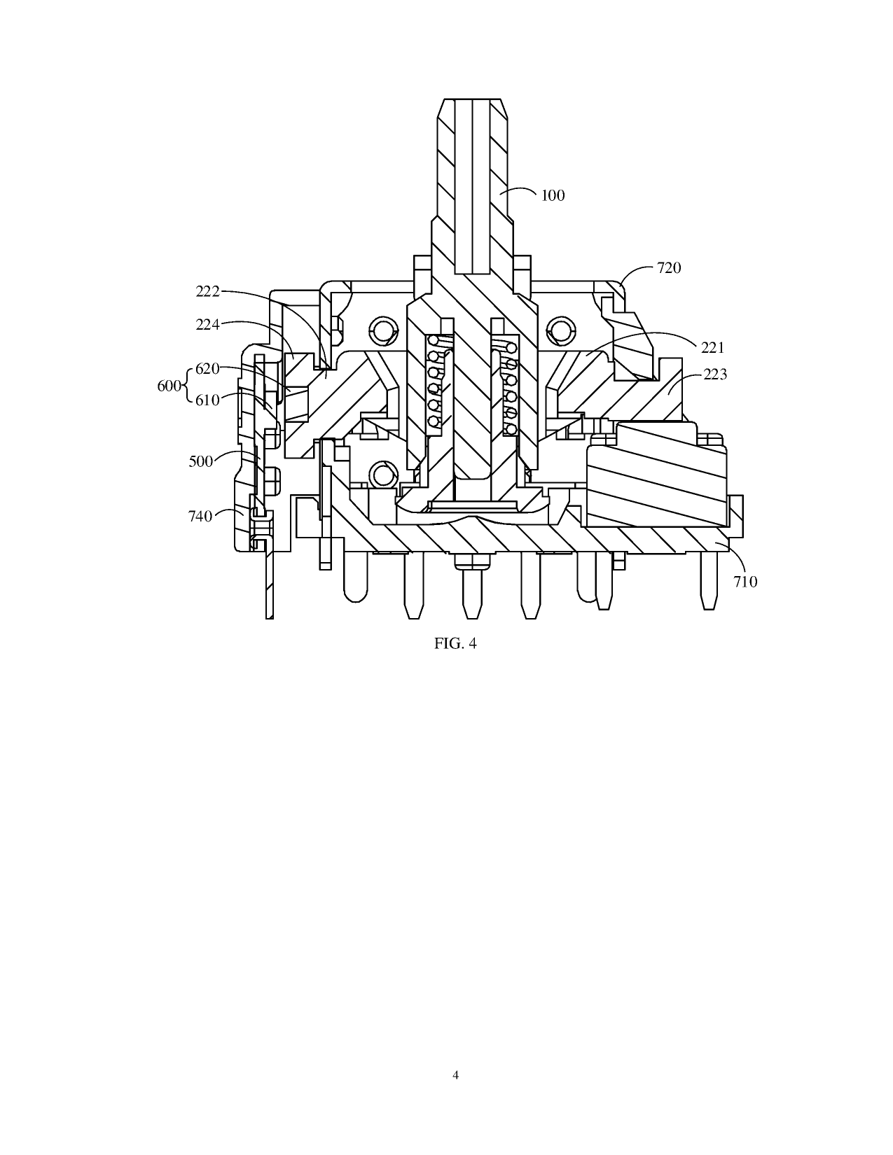

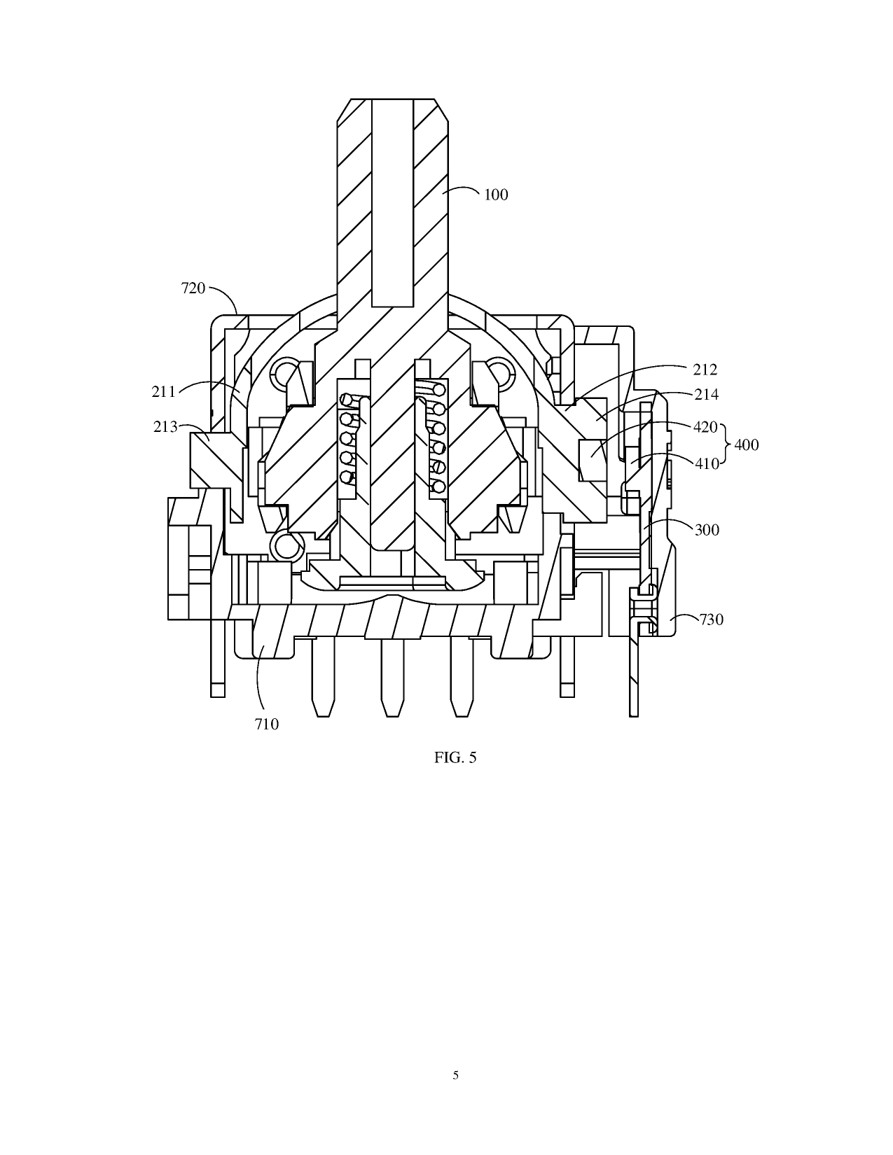

The present application provides a rocker device to enhance the user experience. The rocker device can be used in control devices for games, drones, and other fields. The following description uses gaming as an example. For ease of understanding and explanation, in FIG. 1 to FIG. 5 of this specification, solid arrows indicate grooves.

Please refer to FIG. 1 to FIG. 5, in an embodiment of the present application, the rocker device 10 includes a rocker 100, a rocker arm assembly 200, a first circuit board 300, a first tunnel magneto resistance (TMR) sensing assembly 400, a second circuit board 500 and a second TMR sensing assembly 600. The rocker arm assembly 200 includes an upper rocker arm 210 and a lower rocker arm 220 provided orthogonally to each other, and the rocker 100 passes through the upper rocker arm 210 and the lower rocker arm 220. The first TMR sensing assembly 400 includes a first TMR sensing element 410 and a first magnet 420, the first magnet 420 is provided at the peripheral side of the upper rocker arm 210, and the first magnet 420 is integrally provided with the upper rocker arm 210. The first TMR sensing element 410 is provided at the first circuit board 300 corresponding to the position of the first magnet 420, and is electrically connected to the first circuit board 300. The second TMR sensing assembly 600 includes a second TMR sensing element 610 and a second magnet 620, the second magnet 620 is provided at the peripheral side of the lower rocker arm 220, and the second magnet 620 is integrally provided with the lower rocker arm 220. The second TMR sensing element 610 is provided at the second circuit board 500 corresponding to the position of the second magnet 620, and is electrically connected to the second circuit board 500.

TMR sensors are highly sensitive magnetic field sensors that use the tunnel magneto resistance effect to detect changes in the external magnetic field. As the magnet moves in the direction of motion, the TMR sensor senses the angle of rotation of the magnetic field to determine the rotational position. TMR sensors operate in a saturated magnetic field.

Working principle: When the user moves the rocker 100, the rocker 100 pushes the upper rocker arm 210 or the lower rocker arm 220 to swing. At this time, the position and direction of the first magnet 420 located in the upper rocker arm 210 and the second magnet 620 located in the lower rocker arm 220 change, and the direction and intensity of the magnetic field detected by the first TMR sensing element 410 and the second TMR sensing element 610 change accordingly. The tunnel magneto resistance elements inside the first TMR sensing element 410 and the second TMR sensing element 610 are very sensitive to changes in the magnetic field. They will change their resistance value according to changes in the direction and intensity of the magnetic field. The resistance change of the tunnel magneto resistance element of the second TMR sensing element 610 is converted into a voltage or current signal by the internal bridge circuit and output via the first circuit board 300 and the second circuit board 500. The controller (such as a microcontroller or a dedicated signal processing chip) samples and reads the output signals of the first TMR sensing element 410 and the second TMR sensing element 610, and converts the electrical signals into specific direction and angle data. The processed direction data is transmitted to the game system as an input signal for controlling the game character. The game system adjusts the movement direction and speed of the game character based on these input signals to achieve control of the character.

In this embodiment, the first TMR sensing element 410 and the second TMR sensing element 610 are directly integrated on the circuit board and correspond to the magnets of the upper rocker arm 210 and the lower rocker arm 220. The first TMR sensing element 410 corresponds to the first magnet 420 is integrally provided with the upper rocker arm 210, and the second TMR sensing element 610 corresponds to the second magnet 620 is integrally provided with the lower rocker arm 220. The integrated arrangement of the magnet and the rocker arm prevents the magnet from changing due to loosening or displacement during installation or use, which enables the TMR sensing element to better sense the position change of the magnet, thereby improving the detection accuracy, simplifying the assembly process, and reducing the accuracy problem caused by assembly error. In addition, the integrated design of the magnet and the rocker arm enables the movement of the rocker arm to be better reflected on the magnet, reducing the lag in the signal transmission path and improving the response speed of the system. In addition, due to the characteristics of the output signal of the TMR sensing element, the signal processing system on the circuit board can process these signals more efficiently, thereby further reducing the response delay of the overall system and providing a better user experience.

In an embodiment of the present application, the first magnet 420 is integrally provided with the upper rocker arm 210, and the second magnet 620 is integrally provided with the lower rocker arm 220, including but not limited to an integral molding setting, a 3D printing molding setting or an adhesive bonding setting. In an embodiment, the first magnet 420 is integrally formed with the upper rocker arm 210, the second magnet 620 is integrally formed with the lower rocker arm 220, and the integral molding here refers to an integral injection molding setting.

Regarding the shapes of the first magnet 420 and the second magnet 620, they can be cylindrical, annular and rectangular, and of course, they can also be other regular or irregular shapes. For example, the first magnet 420 is provided in a cylindrical shape, and the second magnet 620 is provided in a cylindrical shape.

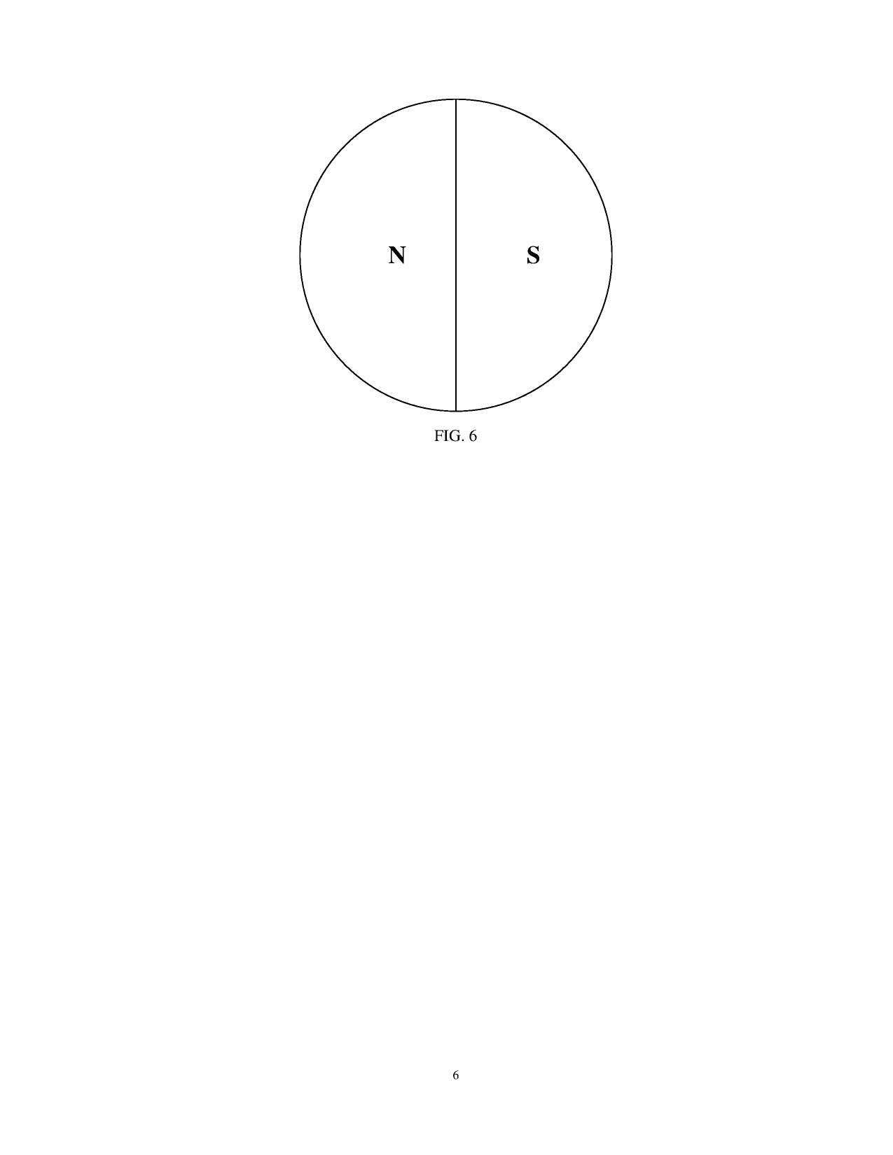

Regarding the polarity distribution of the first magnet 420 and the second magnet 620, there are axial polarization, radial polarization, and bipolar polarization. Taking a cylindrical shape as an example, axial polarization refers to the distribution of the polarity of the magnet along the axial direction of the magnet, and one end surface is the north pole and the other end surface is the south pole. Radial polarization refers to the distribution of the polarity of the magnet along the radial direction (i.e., from the center outward), and the periphery and center of the magnet have different polarities. As shown in FIG. 6, bipolar polarization refers to: the magnet is divided into two halves along the diameter direction, one half of the magnet is the north pole (N pole) and the other half of the magnet is the south pole (S pole). The magnetic field lines pass from the north pole half to the south pole half, forming a continuous magnetic field from one side of the magnet to the other side of the magnet.

In an embodiment, the first magnet 420 is provided with two opposite sides along its radial direction, and the polarities of the two sides of the first magnet 420 are different, that is, the diameter direction of the magnet is the dividing line of the magnetic poles, the one half of the magnet is the N pole and the other half of the magnet is the S pole. In an embodiment, as shown in FIG. 6, the left side can be the north pole and the right side can be the south pole.

In an embodiment, the second magnet 620 is provided with two opposite sides along its radial direction, and the polarities of the two sides of the second magnet 620 are different. In other words, the diameter of the magnet of the magnet is the dividing line of the magnetic poles, one half of the magnet is the N pole and the other half being the S pole. For example, as shown in FIG. 6, the left side may be the north pole and the right side may be the south pole.

In the above two embodiments, the diameter direction of the magnet is the dividing line of the magnetic poles, with the north pole on one side and the south pole on the other side. This distribution method allows the TMR sensing element to better detect obvious magnetic field changes when the magnet rotates or moves, thereby improving detection accuracy.

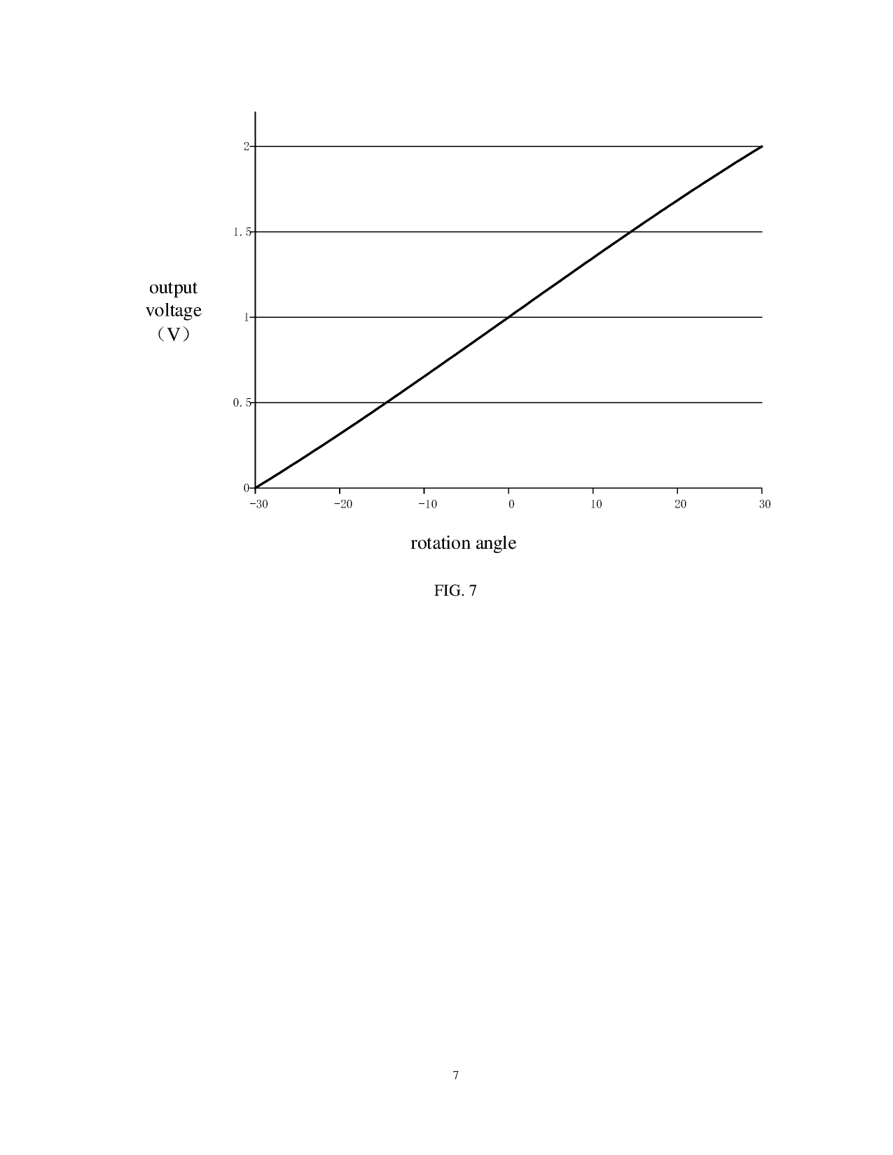

In order to verify the superiority of the technical solution of the present application, the embodiment shown in FIG. 1 was tested, and it was found that when the upper rocker arm 210 and the lower rocker arm 220 swing back and forth 30 degrees, the output curve is shown in FIG. 7, and the output voltage shows a linear change, and the position can be directly calculated linearly.

As can be seen, in the technical solution of this embodiment, since the output voltage of the rocker device 10 exhibits a linear variation, and there is a direct proportional relationship between the linearly varying output voltage and the measured quantity, the processing and interpretation of the sensor output signal becomes very simple and intuitive. Linear transformation can be processed through simple mathematical operations (such as scaling), without the need for complex nonlinear correction algorithms. This also ensures that remote control system errors and random errors are generally evenly distributed across the entire measurement range, thereby reducing the accumulation of total errors, improving overall accuracy, and facilitating integration into larger systems, avoiding the introduction of additional complexity and potential error sources in system design. Furthermore, the linear output simplifies data processing and analysis, and linear signals are easier to convert and process. For example, when converting analog signals to digital signals, the linear relationship allows for the use of simple linear interpolation or scaling algorithms. The linear variation of the output voltage allows the use of high-precision amplification and measurement circuits, allowing even tiny changes to be accurately detected, thereby improving the control accuracy of the rocker device 10.

In an embodiment, the rocker device 10 includes a housing 700, and the housing 700 includes a base 710 and an upper housing 720, and the upper housing 720 is provided at the base 710 and enclosed with the base 710 to form a mounting space. The rocker arm assembly 200 is provided in the mounting space, and one end of the rocker 100 passes through the upper housing 720.

The main function of the housing 700 is to protect the internal electronic components and provide mechanical support. In order to facilitate the installation of various components, the housing 700 includes a base 710 and an upper housing 720, and the base 710 and the upper housing 720 are detachably connected.

In an embodiment, the housing 700 includes a first cover housing 730 and a second cover housing 740 provided at the upper housing 720, and the first circuit board 300 is provided in the first cover housing 730 and located between the upper housing 720 and the first cover housing 730. The second circuit board 500 is provided in the second cover housing 740 and located between the upper housing 720 and the second cover housing 740. In this embodiment, placing different circuit boards in different cover housings can effectively achieve electrical isolation, reduce electromagnetic interference and crosstalk, and further improve the control accuracy of the rocker device 10.

On the basis of the previous embodiment, the first cover housing 730 is provided with a first buckle 731, and the upper housing 720 is provided with a first clamping groove 721 for the first buckle 731 to snap.

In an embodiment, the first cover housing 730 is provided with a limiting column, and the upper housing 720 is provided with a limiting hole or a limiting groove for the limiting column to be connected in a limiting manner; or, the upper housing 720 is provided with a limiting column, and the first cover housing 730 is provided with a limiting hole or a limiting groove for the limiting column to be connected in a limiting manner.

In another embodiment, the second housing 740 is provided with a second buckle 741, and the upper housing 720 is provided with a second clamping groove 722 for the second buckle 741 to snap.

In an embodiment, the second housing 740 is provided with a limiting column and the upper housing 720 is provided with a limiting hole or limiting groove for the limiting column to retain; or, the upper housing 720 is provided with a limiting column and the second housing 740 is provided with a limiting hole or limiting groove for the limiting column to be connected in a limiting manner.

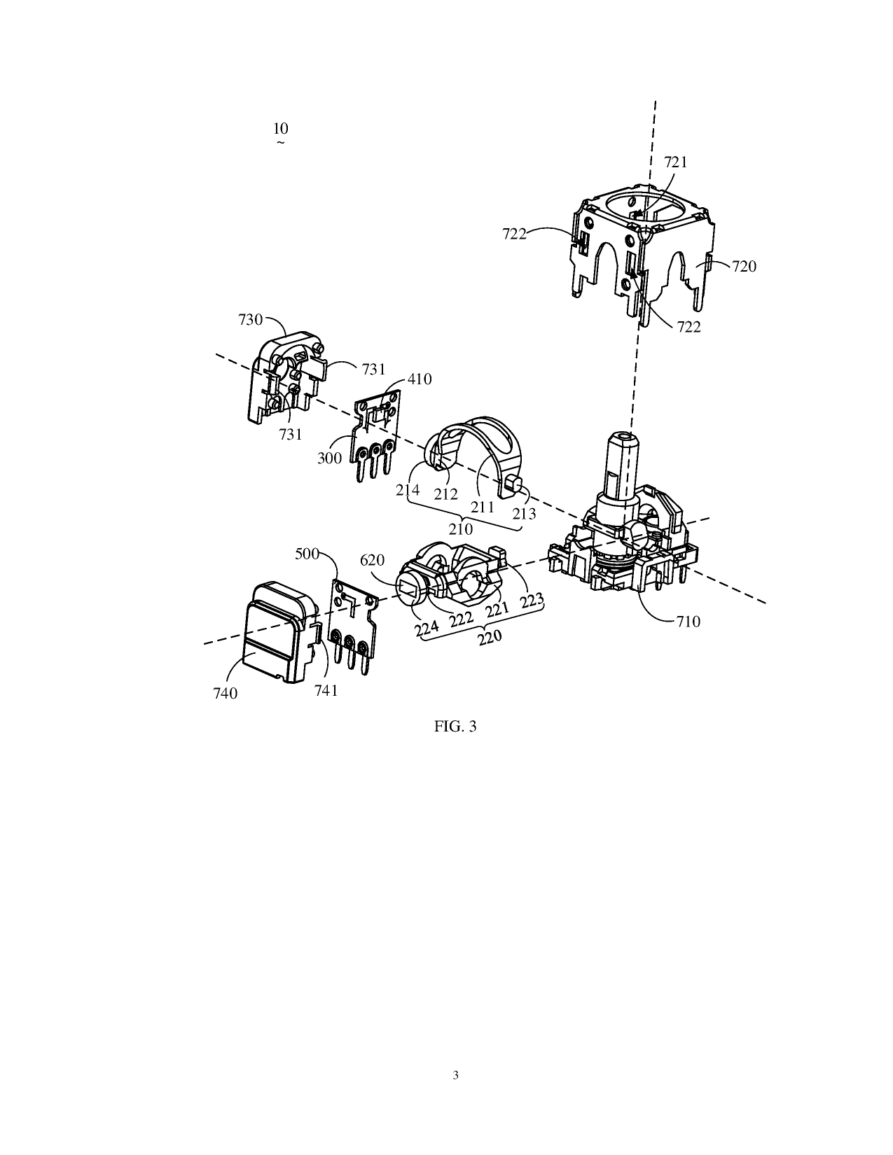

Please refer to FIG. 3 to FIG. 5, in an embodiment, the upper rocker arm 210 includes an upper rocker arm body 211, a first clamping portion 212, a second clamping portion 213 and a first mounting portion 214. The first clamping portion 212 and the second clamping portion 213 are provided at opposite sides of the upper rocker arm body 211, the upper rocker arm body 211 is provided in the mounting space, and a clamping groove for mounting the first clamping portion 212 and the second clamping portion 213 is formed between the base 710 and the upper housing 720. The first mounting portion 214 is provided at the side of the first clamping portion 212 away from the upper rocker arm body 211 and is located between the upper housing 720 and the first cover housing 730, and the first magnet 420 and the first mounting portion 214 are integrally formed.

Please refer to FIG. 3 to FIG. 5, in another exemplary embodiment, the lower rocker arm 220 includes a lower rocker arm body 221, a third clamping portion 222, a fourth clamping portion 223 and a second mounting portion 224. The third clamping portion 222 and the fourth clamping portion 223 are provided at opposite sides of the lower rocker arm body 221, the lower rocker arm body 221 is provided in the mounting space, and a clamping groove for mounting the third clamping portion 222 and the fourth clamping portion 223 is formed between the base 710 and the upper housing 720. The second mounting portion 224 is provided at the side of the fourth clamping portion 223 away from the lower rocker arm body 221 and is located between the upper housing 720 and the second cover housing 740, and the second magnet 620 and the second mounting portion 224 are integrally formed.

The present application also provides a remote control, and the remote control includes a rocker device 10. The specific structure of the rocker device 10 refers to the above embodiment. Since the remote control adopts all the technical solutions of all the above embodiments, it has at least all the beneficial effects brought by the technical solutions of the above embodiments, which will not be repeated here.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A rocker device, comprising:
a rocker;
a rocker arm assembly;
a first circuit board;
a first tunnel magneto resistance (TMR) sensing assembly;
a second circuit board; and
a second TMR sensing assembly,
wherein the rocker arm assembly comprises an upper rocker arm and a lower rocker arm provided orthogonally to each other, and the rocker passes through the upper rocker arm and lower rocker arm;
the first TMR sensing assembly comprises a first TMR sensing element and a first magnet, the first magnet is provided at a peripheral side of the upper rocker arm and integrally provided with the upper rocker arm, and the first TMR sensing element is provided at the first circuit board at a position corresponding to the first magnet and electrically connected to the first circuit board; and
the second TMR sensing assembly comprises a second TMR sensing element and a second magnet, the second magnet is provided at a peripheral side of the lower rocker arm and integrally provided with the lower rocker arm, and the second TMR sensing element is provided at the second circuit board at a position corresponding to the second magnet and electrically connected to the second circuit board.

2. The rocker device according to claim 1, wherein the first magnet and the upper rocker arm are integrally formed, and the second magnet and the lower rocker arm are integrally formed.

3. The rocker device according to claim 2, wherein the first magnet is of a cylindrical shape, and the second magnet is of a cylindrical shape.

4. The rocker device according to claim 3, wherein opposite radial sides of the first magnet and the second magnet have opposite polarities.

5. The rocker device according to claim 1, wherein the rocker device comprises a housing, the housing comprises a base and an upper housing, and the upper housing is provided at the base and enclose with the base to form a mounting space; and
the rocker arm assembly is provided in the mounting space, and an end of the rocker arm passes through the upper housing.

6. The rocker device according to claim 5, wherein the housing comprises a first cover housing and a second cover housing provided at the upper housing, and the first circuit board is provided in the first cover housing and located between the upper housing and first cover housing; and
the second circuit board is provided in the second cover housing and located between the upper and second cover housings.

7. The rocker device according to claim 6, wherein the first cover housing is provided with a first buckle, and the upper housing is provided with a first clamping groove for the first buckle to snap; and
the second cover housing is provided with a second buckle, and the upper housing is provided with a second clamping groove for the second buckle to snap.

8. The rocker device according to claim 6, wherein the upper rocker arm comprises an upper rocker arm body, a first clamping portion, a second clamping portion, and a first mounting portion;
the first clamping portion and the second clamping portion are provided at opposite sides of the upper rocker arm body, the upper rocker arm body is provided in the mounting space, and a clamping groove for mounting the first clamping portion and second clamping portion is formed between the base and the upper housing; and
the first mounting portion is provided at a side of the first clamping portion away from the upper rocker arm body and is located between the upper housing and the first cover housing, and the first magnet and the first mounting portion are integrally formed.

9. The rocker device according to claim 6, wherein the lower rocker arm comprises a lower rocker arm body, a third clamping portion, a fourth clamping portion, and a second mounting portion;
the third clamping portion and the fourth clamping portion are provided at opposite sides of the lower rocker arm body, the lower rocker arm body is provided in the mounting space, and a clamping groove for mounting the third clamping portion and the fourth clamping portion is formed between the base and the upper housing; and
the second mounting portion is provided at a side of the fourth clamping portion away from the lower rocker arm body and is located between the upper housing and the second cover housing, and the second magnet and the second mounting portion are integrally formed.

10. A remote control, comprising the rocker device according to claim 1.
